(19) United States
(12) Patent Application Publication
(10) Pub. No.: US 2026/0289389 A1
(43) Pub. Date: Sep. 24, 2026

(54) MODIFIED CLASSIFIER FRAMEWORK FOR HANDLING REGRESSION-BASED TASKS

(71) Applicant: Optum, Inc., Minnetonka, MN (US)

(72) Inventors: Saumajit SAHA, Bangalore (IN); Sudhanshu SHARMA, Bangalore (IN); Albert Aristotle NANDA, Bengaluru (IN)

(21) Appl. No.: 19/084,994

(22) Filed: Mar. 20, 2025

(51) Int. Cl. G06N 20/00

(52) U.S. Cl. CPC G06N 20/00

(57) ABSTRACT

Various embodiments of the present disclosure provide a machine learning pipeline that improves the functionality of a computer in various aspects. The techniques comprise receiving a code sequence from an input dataset that is based on a target parameter associated with a defined numerical range. The code sequence may comprise a transformation of time series data into a set of code inputs reflective of codes within the time series data. The technique comprise generating, using an embedding layer of a machine learned classification pipeline, a sequence embedding based on the code sequence, generating, using an augmentation layer of the machine learned classification pipeline, a classification embedding by concatenating a time attribute to the sequence embedding, and generating, using a classifier layer of the machine learned classification pipeline, and based on the classification embedding, a classification output for the subsequent measurement of the target parameter.

### BACKGROUND

In various domains, time series data is traditionally used to predict future numerical values by building regression models from observed historical patterns. In some cases, the efficacy of time series forecasting may be limited by traditional regression architectures, which suffer from several technical challenges, including a dependency on historical observations for individual entities, sensitivities to outliers in data, requirements for strict linear relationships, among others, that may reduce the accuracy of regression model. Moreover, regression models are typically built specifically for individual entities and thus require increased memory and processing resources compared to other machine learning approaches, such as machine learning classifiers that are generalizable across entities. While machine learning classifiers may provide several performance advantages, in terms of speed, accuracy, and generalizability, traditional classification architectures are designed for static data and do not effectively capture the temporal dynamics inherent in time series data. This may lead to suboptimal performance when applied to problems where the timing and sequence of events are crucial for accurate predictions.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a classifier augmented monitoring task that applies a modified classifier framework in accordance with some embodiments of the present disclosure.

FIG. 5 depicts a dataflow diagram of a feature engineering process of the modified classifier framework in accordance with some embodiments of the present disclosure.

FIG. 6 depicts a dataflow diagram of an inference and training process of the modified classifier framework in accordance with some embodiments of the present disclosure.

FIG. 7 depicts a flowchart diagram of a classification process in accordance with some embodiments of the present disclosure.

### DETAILED DESCRIPTION

Various embodiments of the present disclosure provide improved machine learning pipelines that improve the functionality of a computer in various contexts. To do so, the present disclosure provides a multi-stage machine learning classification pipeline that employs new feature engineering models to transform time series data into a format tailored for classifier architectures. In this way, the techniques of the present disclosure may leverage advanced machine learning techniques to transform complex time series prediction tasks into more tractable classification problems, enabling more flexible model architectures and improved performance across diverse application domains.

More particularly, the multi-stage machine learning classification pipeline may comprise several stages that incrementally convert a time-series prediction task into a less computationally expensive (e.g., in terms of both inference and training) and more accurate classification process.

At a first stage, the multi-stage machine learning classification pipeline may transform the time series data into a sequence of structured entries (e.g., a code sequence) that represents both the timing and semantic meaning of a set of predictive features expressed by a time series input. The code sequence may be structured according to a textual (or other media type) format to provide an informationally rich input for an embedding layer of the multi-stage machine learning classification pipeline. The embedding layer may then be applied to the code sequence to transform the code sequence into a sequence embedding that encodes the informationally rich input into a fixed vector representation. In this way, at the first stage of the multi-stage machine learning classification pipeline, time series data may be converted into a semantically rich vector that encodes both the semantic and temporal information of the original time series input. By doing so, the techniques of the present disclosure enable the application of various classifier architectures to time series data, while emphasizing (e.g., rather than losing) predictive insights within the original time series input.

At a second stage, the multi-stage machine learning classification pipeline may augment the sequence embedding with additional dimensions to generate a classification embedding that incorporates additional metadata for a downstream classifier. The additional dimensions, for example, may comprise temporal and/or entity-specific information that may contextualize the original time series input and further improve the accuracy of the downstream classifier. For example, by converting the regression task into a classification task, the techniques of the present disclosure may introduce additional, non-time series related data into the predictive process. This, in turn, may improve the accuracy (e.g., in terms of precision and recall) of the classifier relative to regression approaches.

At a third stage, the multi-stage machine learning classification pipeline applies a classifier to the classification embedding to generate a classification output. The classification output may comprise a more accurate, and less complex, abstraction of a predicted numerical value for a target parameter. For example, the classification output may focus on a subrange of a target parameter, rather than a granular numerical prediction of the target parameter. By doing so, the techniques of the present disclosure may train classifier architectures, that traditionally produce deterministic outputs, for time series predictions that traditionally require continuous outputs. Through the use of a classifier architecture and/or by focusing on an abstraction of a numerical prediction, the techniques of the present disclosure may improve the accuracy, speed, and reliability of time series predictions relative to traditional machine learning approaches. In addition to these performance improvements, the resulting classifiers may be more generalizable to new data and may reduce both the storage and processing requirements of time series predictions.

In this way, the multi-stage machine learning classification pipeline provides an improved alternative to traditional time series forecasting techniques that may be limited in their ability to handle complex, multi-modal data inputs and often require extensive historical data for accurate predictions. By converting a time series prediction task into a classification problem, the present disclosure enables more efficient and accurate predictions based on diverse input data. Ultimately, the multi-layered approach of the present disclosure allows for more nuanced and accurate predictions compared to traditional regression-based models as it may capture more complex relationships within the data across multiple dimensions and time scales. By implementing these technical improvements, the present disclosure overcomes challenges in machine learning and data processing fields of technology, particularly in scenarios involving time-dependent inputs. The ability to convert complex time series problems into more manageable classification tasks represents a significant advancement in predictive modeling techniques, offering improved accuracy, efficiency, and adaptability across various domains and applications.

Examples of technologically advantageous embodiments of the present disclosure comprise improved machine learning pipelines that operate in an unconventional manner to transition a regression-based task into a classification task. By doing so, the machine learning pipeline may improve the flexibility of machine learning architecture while generating predictions for numerical data types, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

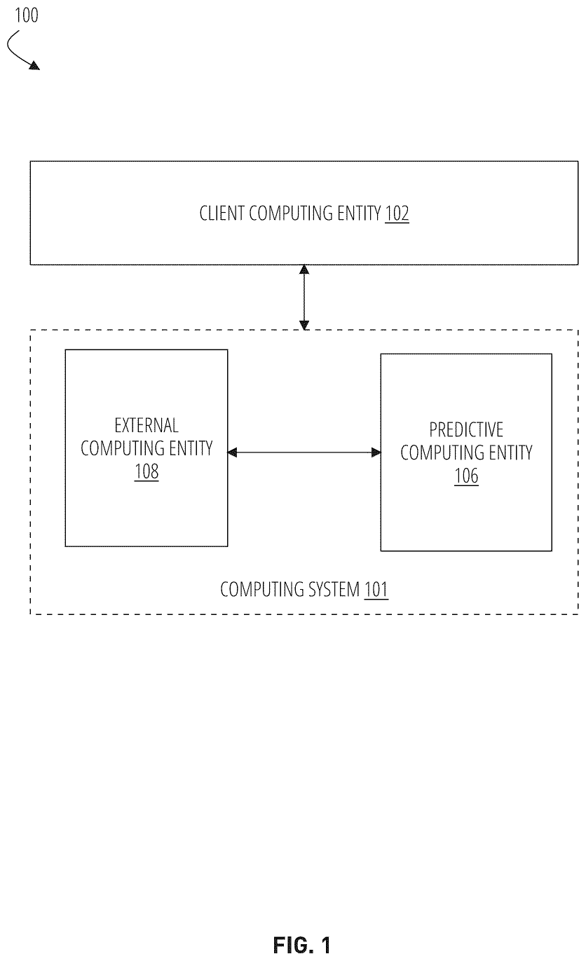

FIG. 1 depicts a block diagram of an example architecture 100 in accordance with some embodiments of the present disclosure. The architecture 100 comprises a computing system 101 configured to receive a request from client computing entities 102, process the request, and provide the response, such as a classification output, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., machine learning techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as the input dataset, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

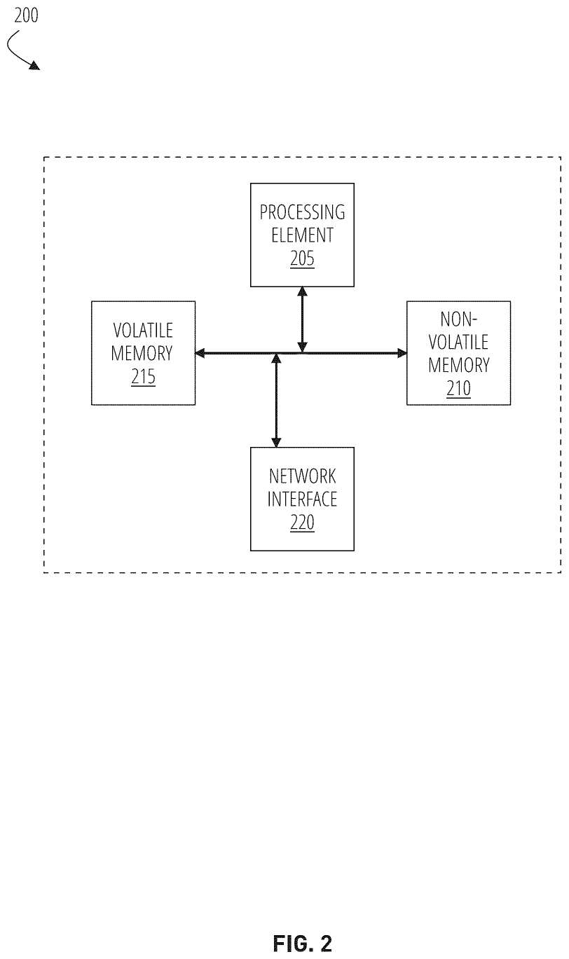

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

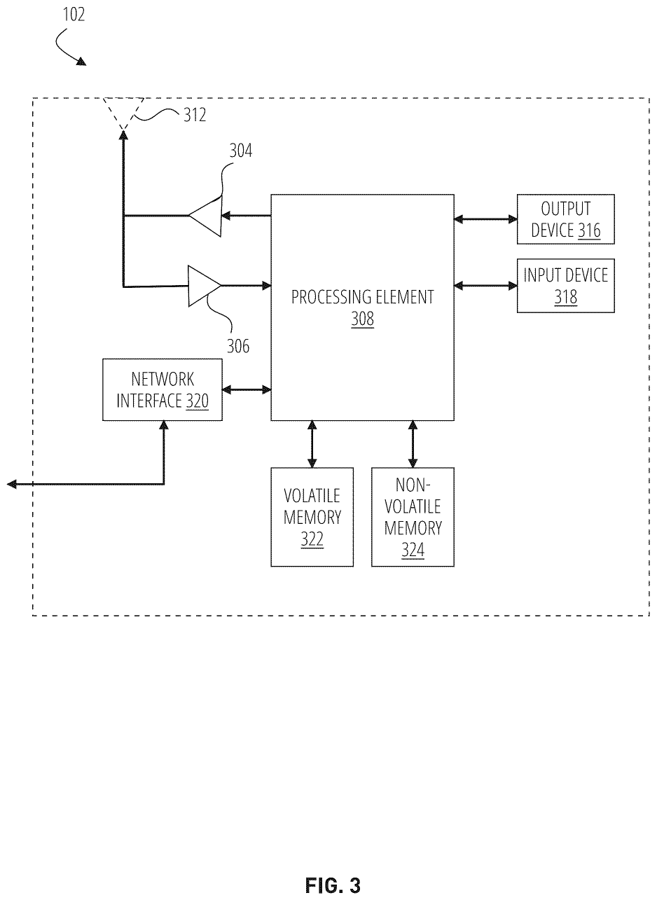

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality. In particular, systems and methods are disclosed herein that implement machine learning and data processing techniques to improve machine learning technology with respect to time series data. By doing so, the machine learning and data processing techniques of the present disclosure enable improved machine learning processes that, when executed on a computer, improves both model training and inference operations in terms of speed, accuracy, and reliability. This, in turn, may improve the functionality of a computer with respect to various computing tasks, including data security, machine learning training, network communication, and the like.

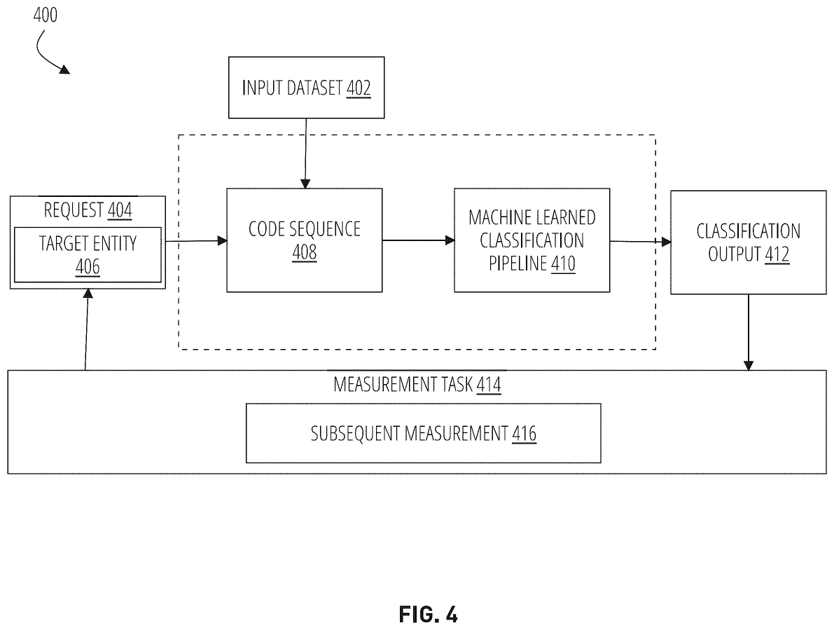

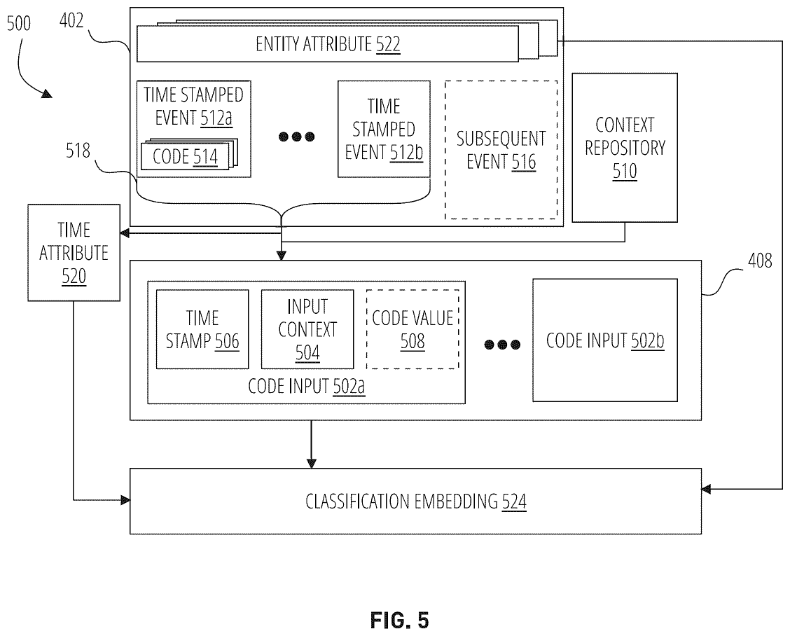

FIG. 4 depicts a dataflow diagram of a classifier augmented monitoring task 400 that applies a modified classifier framework in accordance with some embodiments of the present disclosure. A computing system, such as the computing system 101 described herein, may implement the classifier augmented monitoring task 400 by applying a modified classifier framework that adapts a classifier to a traditionally time series and/or regression-based measurement task 414. To do so, the classifier augmented monitoring task 400 transforms time series data into dense vectors that encode predictive features (e.g., through a series of operations described in FIG. 5) in a format compatible with classifier architectures. By doing so, the classifier augmented monitoring task 400 may apply classifier architectures, rather than regression architectures, to a time series prediction task, such as the measurement task 414. This instills more flexibility to a monitoring process and, by replacing regression architectures with more reliable, efficient, and accurate classifiers, provides a more effective (e.g., in terms of accuracy, time requirements, and memory usage) monitoring solution for various use cases, including patient lab monitoring, computer performance monitoring, machinery health monitoring, among others.

In some embodiments, the computing system 101 receives a request 404 for a target entity 406. The request 404 may comprise a message, application programming interface (API) request, and/or the like. In some examples, the request 404 may correspond to a measurement task 414 for a target parameter. For example, request 404 may correspond to a defined message format for a measurement task 414. The request 404 may identify a target entity 406, the target parameter, and/or may comprise instructions to initiate a classification output 412 for a subsequent measurement 416 of a measurement task 414. As described in further detail herein, the target parameter may be associated with a defined numerical range and the request 404 may initiate a classification output 412 that identifies a predicted subrange of the defined numerical range. In doing so, the request 404 may leverage classifier architectures to predict an abstraction of a future measurement for a measurement task 414. This improves the prediction speeds for the measurement task 414 and allows higher request frequencies among other advantages described herein.

In some embodiments, a target parameter is a dependent variable in a regression-based prediction task, such as a time series forecasting problem. The target parameter may be a numerical data type that is constrained by a defined numerical range. A value of the target parameter may comprise a measurement within the defined numerical range. The target parameter may be configured for any measurement task 414, such as a lab test measurement (e.g., a clinical lab measurement), a computer performance measurement (e.g., an activity monitoring measurement), a machinery monitoring measurement (e.g., a heat measurement), and/or the like. Values for a target parameter may be stored in an input dataset 402 for a target entity 406 and monitored over a time to initiate prediction-based actions. For example, in a clinical setting, values of a target parameter may be stored in a relational database as part of a patient's electronic health record, while in an industrial setting, they may be stored in a time-series database optimized for handling continuous streams of sensor data.

In some examples, the target parameter may provide a key metric for evaluating system performance, triggering alerts, initiating automated responses, and/or the like. For instance, in a clinical setting, if the predicted value of a lab test (e.g., a target parameter) exceeds or falls below a reference range, it could automatically flag a patient for further examination. In an industrial context, predictions of a machinery's heat levels exceeding or falling below a reference temperature range may trigger preventive maintenance protocols. Alternative uses or embodiments of the target parameter may comprise its application in multi-target prediction tasks, where multiple related parameters may be predicted simultaneously. It could also be used in anomaly detection systems, where the focus is on identifying unusual or unexpected values of the target parameter rather than predicting its exact value.

In some embodiments, the target parameter corresponds to a data type with a defined numerical range. The defined numerical range may comprise a numerical range that defines an upper and lower limit for a measurement of a target parameter. This range establishes the boundaries within which a target parameter's value may fall, providing a context for interpreting measurements and predictions. From a technical perspective, the defined numerical range may be implemented as a pair of floating-point and/or integer values stored in a computer's memory. These values represent the lower and upper bounds of the range. In database systems, the defined numerical range may be stored as metadata associated with the target parameter, allowing for efficient querying and data validation. Some database management systems may offer specialized data types for ranges, such as PostgreSQL's range types, which may optimize storage and query performance for range-based operations.

A defined numerical range may depend on the measurement task 414 and/or instrument used to record a measurement for the measurement task 414. By way of example, a target parameter may correspond to a lab test value, such as a Creatinine test that measures Creatinine levels using a Creatinine Meter. In such a case, the defined numerical range may comprise a range of 0 -100 milligrams/deciliter. As another example, a target parameter may correspond to a machinery test value, such as a heating monitor that measures heat within the machinery using a thermometer. In such a case, the defined numerical range may comprise a range of 0 -200 Celsius. As may be seen from the above examples, a target parameter and defined numerical range thereof may be extended to any measurement activity.

In some embodiments, a value for a target parameter is recorded as a recorded measurement at a particular point in time. A recorded measurement, for example, may comprise a data value that represents a previously recorded value of a target parameter for a target entity. This measurement serves as a historical data point, providing context for future predictions and analyses, as described herein. For example, a recorded measurement may be stored in a database (or other storage mechanism) as part of a larger dataset, such as the input dataset 402. In some cases, as described with reference to FIG. 5, the recorded measurement may be stored as a portion of a time stamped event that may comprise other relevant information for a target entity 406, such as a timestamp of the recorded measurement, an identity of the target entity 406, and/or any contextual metadata. In a time-series database, which may be optimized for handling sequential data, a series of recorded measurements may be stored along with their timestamps in a format that allows for efficient querying of historical trends.

In some examples, a recorded measurement for the measurement task 414 may serve as an input to a machine learned classification pipeline 410 to predict and/or proactively address a subsequent measurement 416 of the measurement task 414 before the subsequent measurement 416 is recorded. For example, a recorded measurement may be recorded, using an instrument corresponding to the target parameter, during a historical instance of the measurement task 414. In some cases, the recorded measurement directly (or indirectly) preceding the subsequent measurement 416 may be used to modify the performance of an upcoming measurement task 414 for recording the subsequent measurement 416, as described herein. In this way, using the techniques of the present disclosure, a single recorded measurement may serve as a reference point for detecting anomalies and/or monitoring the performance and/or health of a target entity 406. In clinical settings, for example, a recorded measurement may be used to predict a progression of a patient's condition at a subsequent time. In industrial applications, a recorded measurement may be used to monitor the performance of machinery and detect potential issues before they become critical.

In some embodiments, a target entity 406 is an entity that is associated with an input dataset 402 and/or identified by the request 404. The target entity 406 may be the subject of the operations of the present disclosure and may depend on the form of the target parameter and/or use case of the machine learned classification pipeline 410. By way of example, in a clinical setting a target entity 406 may comprise a patient that is associated with an electronic health record. As another example, in a computer monitoring use case, the target entity 406 may comprise a computer that is associated with an activity log. As yet another example, in an industrial use case, the target entity 406 may comprise machinery that is associated with a performance and/or health profile.

The target entity 406 may be represented in a computer system as a unique identifier and/or a set of identifiers. In a relational database, the target entity 406 may be a primary key in a table dedicated to entities. In object-oriented programming, the target entity 406 may be instantiated as an object with various attributes and methods. In graph databases, the target entity 406 may be represented as a node with multiple edges connecting it to related data points, such as the time stamped events described herein. In any form, the target entity 406 may serve as the focal point for the generation of a code sequence 408 and/or derivatives thereof. The target entity 406, for example, may enable an aggregation of the input dataset 402 and/or an extraction of a sequence of codes, and/or other predictive features, from the input dataset 402.

In some embodiments, the computing system 101 receives a code sequence 408 from an input dataset 402 that is based on the target parameter associated with the defined numerical range and/or the target entity 406. The code sequence 408 may be received and/or generated using an input dataset 402 that corresponds to (e.g., is aggregated for) the target entity 406. For example, as described with reference to FIG. 5, the code sequence 408 may be extracted from the input dataset 402 in accordance with a feature engineering process 500 tailored to the machine learned classification pipeline 410.

In some examples, the input dataset 402 comprises reference data for the target entity 406. In addition, or alternatively, the input dataset 402 may be curated for a target parameter. For example, the input dataset 402 may comprise a portion of the reference data associated with target entity 406 that is relevant to a target parameter.

In some examples, the input dataset 402 may depend on the target parameter, the target entity 406, and/or the use case of the machine learned classification pipeline 410. For example, in a clinical setting, the input dataset 402 may comprise an aggregation of one or more electronic health records that reflect one or more lab tests, diagnosed medical codes (e.g., current procedural terminology (CPT), international classification of diseases (ICD)), and/or patient attributes for a patient. As another example, in a computer setting, the input dataset 402 may comprise an aggregation of one or more activity logs that reflect one or more application runtimes, detected program errors, and/or computer attributes for a computer. As yet another example, in an industrial setting, the input dataset 402 may comprise an aggregation of one or more performance logs that reflect one or more machine performance measurement, run frequencies, and/or machine attributes for machinery.

In any use case, the input dataset 402 may be stored in a database system, which may be a relational database for structured data, a document database for semi-structured data, a specialized time-series database for sequential data points, a graph database, and/or any other data structure. In some examples, the input dataset 402 may be maintained through aggregation operations from various disparate computing sources (e.g., electronic health records, sensor logs), cleaning operations to handle missing and/or erroneous values, data transformation operations to convert raw data into a format suitable for analysis, data loading operation to load data within a centralized environment, and/or the like. By way of example, the input dataset 402 may be maintained through an extract, transform, load (ETL) data pipeline configured for the one or more operations of the present disclosure.

In some embodiments, the computing system 101 generates, using a machine learned classification pipeline 410, a classification output 412 for the measurement task 414. The classification output 412, for example, may comprise a class prediction for a numerical value recorded by a subsequent measurement 416 performed during the measurement task 414.

In some embodiments, the subsequent measurement 416 is to a data value that represents an anticipated value of a target parameter for the target entity 406 at a current and/or future time. Due to its defined numerical range, subsequent measurements 416 for a target parameter are traditionally predicted using time series and/or regression analysis. Such techniques present several technical challenges, including a reliance on robust individual datasets for accuracy, increase storage and training requirement for handling entity-specific models, among other disadvantages. To address these challenges, the classification output 412 may provide an abstraction to a subsequent measurement 416 that predicts a subrange within which the subsequent measurement 416 is predicted to land. By doing so, the techniques of the present disclosure may transform a traditionally regression-based analysis to a classification-based analysis in which the machine learned classification pipeline 410 may be applied.

In some examples, the subsequent measurement may correspond to a measurement time (e.g., the timing of the measurement task 414). The computing system 101 may initiate, at the measurement time, a measurement for the target parameter based on the classification output 412. For instance, the computing system 101 may initiate the measurement by prioritizing the target entity relative to a set of entities based on the classification output 412. In addition, or alternatively, the computing system 101 may modify the measurement time to downgrade and/or upgrade the priority of the measurement task 414, control the target entity (e.g., lock a computer, halt the operation of a machinery) to proactively address an expected measurement before it is recorded, and/or the like. In this way, the computing system 101 may implement a classification approach to entity monitoring that may be executed with less computing resources, relative to regression counterparts, and in real time to continuously monitor and/or act on behalf of an entity in response to abstracted predictive insights (e.g., classifications rather than granular numerical predictions) of the entity's operation.

FIG. 5 depicts a dataflow diagram of a feature engineering process 500 of the modified classifier framework in accordance with some embodiments of the present disclosure. The feature engineering process 500 comprises a series of operations that transform data from a time series format (e.g., a set of time stamped events 512a-b) to a new format compatible with embedding and classifier layers of a machine learned classification pipeline. In this way, the feature engineering process 500 may be implemented by a computing system, such as the computing system 101 described herein, to covert a time-series and/or regression task into a classification task that may leverage more efficiently performing (e.g., in terms of speed, accuracy, and time/storage requirements) classification architectures to make predictions for a subsequent event 516.

In some embodiments, the computing system 101 extracts and/or converts time series data from the input dataset 402 to generate a code sequence 408 that is compatible with an embedding layer of a downstream machine learned classification pipeline. The time series data of the input dataset 402, for example, may comprise a set of time stamped events 512a-b. The time stamped events 512a-b, for example, may comprise data object, database records, and/or the like that record a set of attributes corresponding to a particular point in time. A time stamped event 512a, for example, may record data associated with a preceding measurement task and/or other event associated with a target entity. The events may be based on the input dataset 402 and/or use case thereof. For example, in a clinical setting, the time stamped event 512a may comprise a clinical touchpoint, such as a clinical visit, clinical engagement, and/or the like, during which clinical data may be recorded for a target entity. As another example, in a computer setting, the time stamped event 512a may comprise a computer touchpoint, such as an activity analysis capture, a debugging operation, and/or the like, during which computer data may be recorded for a target entity. As yet another example, in an industrial setting, the time stamped event 512a may comprise a machinery touchpoint, such as a performance test, and/or the like, during which machinery data may be recorded for a target entity.

In some embodiments, up to each of the time stamped events 512a-b comprises a time stamp and/or one or more codes 514 or values corresponding to the time stamp. In some examples, a code 514 may comprise a predictive indicator within the input dataset 402 that is initially stored with reference to a time stamped event 512a. A code 514 may depend on the target parameter. For a clinical target parameter, such as a lab test measurement, the code 514 may comprise a set of clinical codes, such as ICD codes, CPT codes, lab test codes, and/or the like. For a machinery target parameter, the code 514 may comprise a set of error codes, activity codes, and/or the like.

In any domain, a code 514 may be implemented as a unique identifier in a computer system, such as a string, an integer, and/or a more complex data structure depending on the specific requirements of the system. The code 514 serves as a standardized way to represent complex concepts and/or events in a concise, machine-readable format. They allow for efficient storage, retrieval, and analysis of data. For example, in a clinical setting, a single ICD code may encapsulate a complex medical diagnosis, allowing for quick reference and statistical analysis across large patient populations. In some cases, codes 514 may be defined in a context repository 510 that links an instance of a code 514 within the input dataset 402 to an input context 504 that describes a meaning (e.g., description, depiction, associated attributes) of the code 514 and/or other relevant metadata. By way of example, the context repository 510 may comprise a lookup table, relational database, graph data structure, and/or the like that stores one or more input contexts 504 for up to each of a set of defined codes for a particular use case.

In some embodiments, a time stamp 506 is a time indicator that corresponds to a time stamped event 512a within the input dataset 402. As described herein, the time stamp 506 may be attributed to up each code 514 within a time stamped event 512a to generate a set of code inputs 502a-b from a time stamped event 512a. In such a case, the time stamp 506 may correspond to an individual code within a code input 502a rather than a time stamped event 512a. In any case, for example whether present in the input dataset 402 or a code sequence 408 derived at least partially from the input dataset 402, the time stamp 506 may indicate a timing of an event corresponding to an identification and/or occurrence of a code 514. A time stamp may be comprising an absolute and/or relative time indicator. For example, the time stamp 506 may comprise a standardized date-time data value (e.g., stored as a Unix timestamp (number of seconds since a specific epoch), an ISO 8601 formatted string, or as a specialized datetime object provided by the programming language or database system in use), a relative period time from a preceding point in time (e.g., a number of days, hours, minutes, or seconds from a first time stamped event, a preceding time stamped event, a preceding or last recorded measurement for a measurement task, and/or the like).

In some embodiments, the input dataset 402 comprises set of time stamped events 512a-b that precede a subsequent event 516. For example, the set of time stamped events 512a-b may correspond to a predictive time period 518 comprises a period of time before the subsequent event 516. As described herein, the computing system 101, using the feature engineering process 500, may convert the set of time stamped events 512a-b, occurring over the predictive time period 518, into a set of code inputs 502a-b to transform the time series data into a code sequence 408 that may be used as a basis for a classification output for the subsequent event 516.

In some embodiments, the code sequence 408 comprises a set of code inputs 502a-b that is arranged in accordance with the set of time stamps associated with the set of time stamped events 512a-b within the input dataset 402. The set of time stamps, for example, may correspond to a set of codes within the input dataset 402. In some examples, the set of time stamps may occur within the predictive time period 518. The predictive time period 518 may occur after a recorded measurement for the target parameter and/or before a subsequent measurement 416 for the target parameter. By way of examples, the recorded measurement may occur during a first time stamped event 512a. The predictive time period 518 may comprise the time stamped event 512a and/or may occur after the time stamped event 512a. By way of example, the set of code inputs 502a-b may comprise an initial code input that comprises the recorded measurement, a measurement time stamp corresponding to the recorded measurement, and/or a contextual description of the target parameter. In addition, or alternatively, the set of code inputs 502a-b may comprise one or more code inputs 502a that comprise a code 514 occurring after a recorded measurement preceding the subsequent event 516 and/or a time stamp 506 and/or input context 504 corresponding to the code 514.

In some embodiments, up to each of the code inputs 502a-b comprises a time stamp 506 of the set of time stamps, an input context 504, and/or a code value 508 corresponding to an instance of a code 514 of the set of codes. An instance of the code 514, for example, may comprise a presence of a defined code within one of the set of time stamped events 512a-b. In some examples, the code sequence 408 comprises a code input 502a for up to each occurrence of a code within a set of time stamped event 512a-bs. For example, a first code of a set of defined codes may be associated with a different code input 502a for up to each of the set of time stamped events 512a-b within which it occurs (e.g., recorded, detected).

In some embodiments, the code input 502a is a structured data entry within a code sequence 408 that codifies a set of attributes for a code 514. The code input 502a, for example, may comprise a time stamp 506, an input context 504, and/or a value, if available, that may be arranged in accordance with a particular format, such as “<time stamp 506> <input context 504> <Value>.” By way of example, a code input 502a may comprise a struct, a class, a dictionary, an XML element, and/or any other structured representation within a computing system 101. The structure of the code input 502a may define a set of fields, including a time stamp field, an input context field, a value field, and/or the like that correspond to one or more attributes of an instance of a code 514 within the input dataset 402.

In some embodiments, the input context 504 for a code 514 comprises a textual description, a descriptive image, and/or any other media or encoded data type that describes one or more attributes of a code 514. The input context 504, for example, may comprise a descriptive counterpart to a code 514. The information and/or format of the information provided by an input context 504 may depend on the use case. For example, in a clinical use case, the input context 504 for an ICD code may comprise a textual description or descriptive image of the ICD code that summarizes the use of the ICD code, such as a disease indicated by the ICD code, and/or the like. As another example, in an industrial use case, the input context 504 for an error code may comprise a textual description or a descriptive image of the error code that summarizes the triggers for the error code within a machinery, and/or the like.

In some examples, an input context 504 may be stored, maintained, and/or updated within a data structure separate from the input dataset 402. For example, an input context 504 may be defined within a universal code repository, such as the context repository 510, that maintains an input context 504 for up to each of a set of defined codes.

In some embodiments, the computing system 101 generates up to each of the set of code inputs 502a by extracting a code 514 and/or time stamp 506 from a time stamped event 512a, mapping an input context 504 to the code 514 from the context repository 510, and storing the input context 504 with the time stamp 506. In addition, or alternatively, if available, the computing system 101 may extract a code value 508, such a recorded measurement, a binary indicator, and/or the like, from the time stamped event 512a that corresponds to the code 514. A code value 508, for example, may be stored for a subset of defined codes if recorded within the input dataset 402. For instance, a code 514 that identifies the performance of a previous measurement task may comprise a recorded measurement. To account for such codes, the computing system 101 may store the code value 508 with the time stamp 506 and/or input context 504 of the code input 502a.

In some embodiments, a code sequence 408 comprises a container of the set of code inputs 502a-b. The form of the container may depend on a format of the input context 504. For example, in the event that the input context 504 comprises a textual description, the code sequence 408 may comprise a textual sequence, such as a sentence, and/or the like. In addition, or alternatively, in the event that the input context 504 comprises descriptive images, the code sequence 408 may comprise a sequence of annotated images. In this manner, a code sequence 408 may comprise a textual sequence, a sequence of annotated images, and/or the like that represents a structured form of data that captures relevant information about a target entity and/or target parameter over a predictive time period 518. By doing so, the code sequence 408 may serve as a temporal representation of events and/or states related to a target entity that allows for the application of classifier architectures.

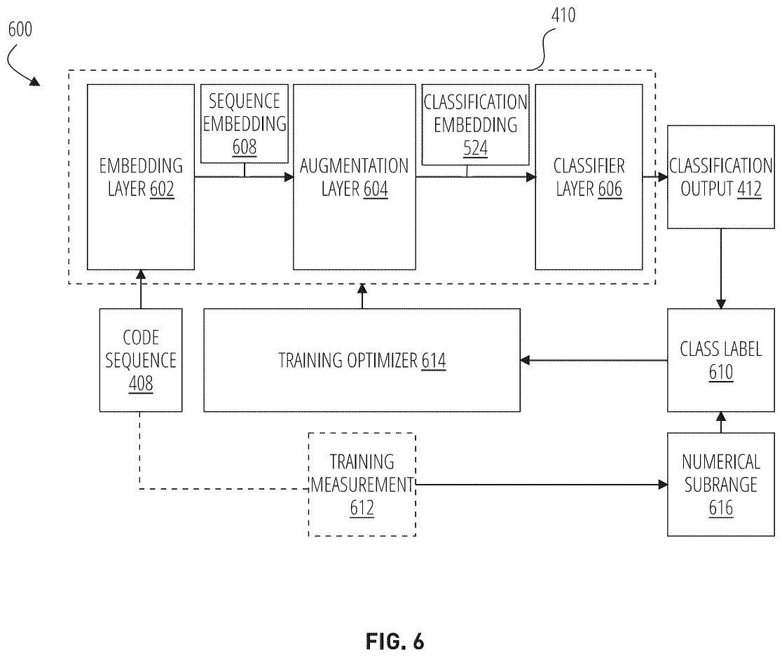

In some embodiments, as described herein with reference to FIG. 6, the computing system 101 aggregates predictive features (e.g., encoded within a sequence embedding) from the code sequence 408 with additional features from the input dataset 402 to generate a classification input, classification embedding 524, for a classifier of the machine learned classification pipeline. The additional features, for example, may comprise a time attribute 520 and/or one or more entity attribute 522. The time attribute 520, for example, may indicate a duration of time between (e.g., inclusive or exclusive of) a recorded measurement (e.g., recorded at the time stamped event 512a) for the target parameter and a subsequent measurement (e.g., recorded at the subsequent event 516) for the target parameter. By way of example, the time attribute 520 may comprise a data value that provides overall timing information for a code sequence 408. The time attribute 520 may indicate a duration between (e.g., inclusive or exclusive of) a previously recorded measurement of a target parameter and the subsequent measurement 416 of the target parameter (e.g., the time between a previous measurement and a next measurement that is the subject of the predictive process).

In some embodiments, the entity attributes 522 comprise one or more data values that provide entity-specific information for a code sequence. The entity attribute 522 may depend on the use case. For example, in a clinical use case, the entity attributes 522 may comprise demographic attributes, such as age, gender, location, and/or the like, that may be predictive of a subsequent measurement at the subsequent event 516. In as another example, in an industrial use case, the entity attributes 522 may comprise usage attributes, such as use frequency, use location, environmental attributes at the use location, and/or the like, that may be predictive of a subsequent measurement at the subsequent event 516.

As described in further detail with reference to FIG. 6, the time attribute 520 and/or entity attributes 522 may be concatenated to a sequence embedding of the code sequence 408 to generate a classification embedding for a downstream classifier of a machine learned classification pipeline. In this regard, the time attribute 520 and/or entity attribute 522 may be transformed to single dimensional representations (e.g., single digit numerals, such as binary indicators) that represent the time attribute 520 and/or entity attributes 522 in a condensed format. By way of example, a gender attribute may be stored as a binary indicator (e.g., “0” for male or “1” for female), an age attribute may be stored as a integer (e.g., 0-100), a time attribute 520 may be stored an another integer (e.g., 1-1000 days), and/or the like.

FIG. 6 depicts a dataflow diagram of an inference and training process 600 of the modified classifier framework in accordance with some embodiments of the present disclosure. As depicted, the inference and training process 600 may leverage a multi-layered machine learned classification pipeline 410 that comprises an embedding layer 602, an augmentation layer 604, and/or classifier layer 606. A computing system, such as the computing system 101, may implement the inference and training process 600 to train and use the machine learned classification pipeline 410 for a traditionally regression-based process. To do so, the machine learned classification pipeline 410 may be configured for a code sequence 408 that, as described herein, may transform a time series data into a format that is compatible the various layers of the machine learned classification pipeline 410.

In some embodiments, the machine learned classification pipeline 410 is a multi-layered model that comprises a jointly and/or individually trained set of connected layers, the embedding layer 602, the augmentation layer 604, and the classifier layer 606. As depicted, the machine learned classification pipeline 410 may be trained and/or configured to generate a classification output 412 for a target parameter based on a code sequence 408 extracted from an input dataset for a target entity. For example, up to each of the layers of the machine learned classification pipeline 410 may comprise machine learned and/or rule-based components that are configured for a particular portion of an end-to-end classification process. For instance, the embedding layer 602, augmentation layer 604, and/or classifier layer 606 may be connected through one or more messaging pathways (e.g., APIs) and configured to pass one or more intermediate representations between one another to iteratively process a code sequence 408 according to a defined framework.

By way of example, at a first layer, the embedding layer 602, the machine learned classification pipeline 410 may transform the code sequence 408 into a sequence embedding 608 and pass the sequence embedding 608 to a subsequent layer, the augmentation layer 604. At a second layer, the augmentation layer 604, the machine learned classification pipeline 410 may augment the code sequence 408 with additional features to generate a classification embedding 524 and provide the classification embedding 524 to a subsequent layer, the classifier layer 606. At a third layer, the classifier layer 606, the machine learned classification pipeline 410 may generate a classification output 412 from the classification embedding 524.

More particularly, in some embodiments, the computing system 101 generates, using the embedding layer 602 of the machine learned classification pipeline 410, the sequence embedding 608 based on the code sequence 408. In some embodiments, the sequence embedding 608 comprises an embedded representation of a code sequence 408. The sequence embedding 608, for example, may comprise an image embedding, a text embedding, and/or any other form of embedded representation. In any form, the sequence embedding 608 may comprise a fixed-size vector that represents an entire input sequence (e.g., the code sequence 408). For instance, the sequence embedding 608 may comprise a dense, continuous representation of a discrete code sequence 408 that captures semantic and/or structural similarities in the input space, such that similar inputs have similar embeddings. By way of example, in a textual implementation, the sequence embedding 608 may comprise a 768-dimensional sentence vector that gives a pooled representation of the entire context of the code sequence 408.

The sequence embedding 608 may compress a variable-length code sequence 408 into a fixed-size representation that may be used as input to downstream machine learning models within the machine learned classification pipeline 410. For example, the sequence embedding 608 may capture an overall meaning and/or content of an entire code sequence 408 in a single vector. In addition, or alternatively, the sequence embedding 608 may comprise one or more embeddings (e.g., vectors) for a code sequence 408. By way of example, the sequence embedding 608 may comprise a set of embeddings at different levels of granularity (e.g., word-level, sentence-level, document-level, pixel-level, color-focused, positioning-focused embeddings) to capture information at multiple scales of the code sequence 408. In some examples, the sequence embedding 608 may be designed to be disentangled, with different dimensions of the embedding vector corresponding to interpretable aspects of the sequence content.

In some embodiments, the embedding layer 602 comprises a machine learned embedding model configured to encode the code sequence 408. The architecture, framework, and/or training of the machine learned embedding model may be tailored to a data type of a code's input context and/or a format of the code sequence 408. By way of example, the embedding layer 602 may comprise machine learned text embedding model for a textual sequence, a machine learned image embedding model for a sequence of annotated images, and/or the like.

For example, the embedding layer 602 may comprise a machine learned encoder that comprises any encoding architecture, such as text-based encoders (e.g., MedBERT), image-based encoders (e.g., contrastive language-image pretraining (CLIP) model), and/or the like. In some examples, a CLIP model may be used as at least part of extracting features from and embedding text and image features, e.g., as a multimodal embedding. The embedding layer 602, for example, may comprise a neural network layer, such as recurrent neural networks (RNNs), convolutional neural networks (CNNs), transformer models, and/or the like that maps high-dimensional, sparse input data (e.g., one-hot encoded words, image pixels) to dense, lower-dimensional vector representations. In some examples, an output of the neural network layers may be passed through a pooling operation (e.g., mean pooling, max pooling) to create a single, fixed-size representation. In some examples, the embedding layer 602 may be implemented as a lookup table for efficiency, where each input token and/or feature may be mapped to a learned vector.

In some examples, the embedding layer 602 may be configured for a particular embedding space. The dimensionality of the embedding space may comprise a hyperparameter that balances between expressiveness (e.g., higher dimensions) and generalization (e.g., lower dimensions). In this manner, the embedding layer 602 may be modified to transform raw input data into a vector of a specific dimensionality based on a level of granularity required for a classification output 412 of a measurement task.

In some examples, the embedding layer 602 may be pretrained using domain-agnostic data and/or fine-tuned using domain-specific data, such as the input datasets for one or more target entities.

In some embodiments, the computing system 101 generates, using an augmentation layer 604 of the machine learned classification pipeline 410, a classification embedding 524 based on the sequence embedding 608. For example, the computing system 101 may generate the classification embedding 524 by concatenating the time attribute (and/or entity attributes) to the sequence embedding 608. As described herein, the time attribute may indicate a duration of time between a recorded measurement for the target parameter and a subsequent measurement for the target parameter. In some examples, the computing system 101 may further concatenate, using the augmentation layer of the machine learned classification pipeline, a set of entity attributes to the sequence embedding.

In some embodiments, the augmentation layer 604 comprises a retrieval model that is configured to retrieve a set of attributes and/or concatenate the attributes to create a classification embedding 524. The augmentation layer 604 may comprise a rule-based layer that defines a set of operations for augmenting the sequence embedding 608 with a set of supplemental features, such as the time attribute and entity attributes described herein. The augmentation layer 604, for example, may receive the sequence embedding 608 of the embedding layer 602, receive the set of supplemental features, and concatenate the supplemental features to the sequence embedding 608 to enhance the dimensionality of the sequence embedding 608. By way of example, the augmentation layer 604 may add the time attribute as an additional dimension to the end of the sequence embedding 608 (e.g., to convert a 768-dimensional sentence vector to a 769-dimensional sentence vector). In addition, or alternatively, the augmentation layer 604 may add one or more entity attributes as additional dimensions to the end of the sequence embedding 608 (e.g., after the time dimension to convert the 769-dimensional sentence vector to a 770-dimensional sentence vector for one entity attribute, 771-dimensional sentence vector for two entity attributes, and so on).

In some embodiments, the classification embedding 524 comprises a sequence embedding 608 with additional dimensions added to incorporate features excluded from the code sequence 408, such as overall timing information and/or ancillary entity-specific information. A classification embedding 524, for example, may comprise a vector that combines the sequence embedding 608 with additional predictive features. This may be achieved through concatenation, element-wise addition, or more complex fusion mechanisms. The resulting vector may comprise a higher dimensionality than the original sequence embedding 608. In this way, the classification embedding 524 may combine the rich contextual information captured in the sequence embedding 608 with relevant metadata to allow a downstream classifier layer 606 to make more accurate and/or nuanced classification decisions.

In some embodiments, the computing system 101 generates, using the classifier layer 606 of the machine learned classification pipeline 410, and based on the classification embedding 524, the classification output 412 for the subsequent measurement of the target parameter. The classifier layer 606 of the machine learned classification pipeline 410 may comprise a machine learned classifier within the larger machine learning model architecture of the machine learned classification pipeline 410. The classifier layer 606, for example, may comprise a final, machine learned stage in a multi-stage machine learning pipeline, responsible for generating classification outputs 412 based on intermediate representation output by the preceding stages of the pipeline. The classifier layer 606 may be implemented using various classification architectures, such as random forest classifiers, neural networks, and/or the like, depending on the specific requirements of the classification task.

In some examples, the classifier layer 606 may be trained using high-dimensional feature representations (e.g., classification embedding 524) generated by preceding layers in the machine learned classification pipeline 410. The classifier layer 606, for example, may apply learned decision boundaries and/or probability distributions to the high-dimensional feature representations to assign input samples to predefined classes and/or categories, such as class label 610. The classifier layer may be designed to handle various types of classification tasks, including binary classification (e.g., normal vs. abnormal), multi-class classification (e.g., less than, within, or beyond a reference range), and/or the like. The flexibility of the classifier layer 606 allows it to be adapted to different domains and prediction tasks, such as forecasting lab test results, predicting performance degradations, and/or the like, without requiring significant changes to the overall model architecture.

In some embodiments, the classification output 412 comprises class prediction output by the machine learned classification pipeline 410. The classification output 412 may represent an abstracted prediction of a numerical subsequent measurement for a measurement task. In this regard, the classification output 412 may indicate a predefined category, class, and/or the like, within which an input sample belongs, based on the features and patterns present in the input data. The classification output 412 may take various forms depending on the specific classification task and model architecture. In binary classification problems, the output may comprise a single value indicating the predicted class (e.g., 0 or 1) and/or a probability score representing the likelihood of belonging to a particular class. For multi-class classification tasks, the classification output 412 may comprise a vector of probabilities, with each element corresponding to the likelihood of the input belonging to a specific class, or a single integer representing the predicted class.

In some examples, the classification output 412 may comprise a prediction about a subsequent measurement and/or state of a target parameter for a target entity, such as forecasting whether a lab test result, an activity level, a temperature, and/or the like will be within, above, or below a particular range. In this manner, the classification output 412 may serves as the basis for downstream decision-making processes and/or actions in lieu of a more complex numerical prediction. For example, in a healthcare setting, the classification output 412 may be used to prioritize patients for medical attention, recommend specific diagnostic tests, initiate treatments, and/or the like. As another example, in an industrial setting, the classification output 412 may be used to halt that operation of machinery, prioritize machinery for maintenance, initiate a maintenance activity, and/or the like. In this manner, the classification output 412 may provide more accurate abstractions of a numerical prediction that may may be generate with increased frequency to directly influence action prior to a measurement task.

In some examples, the classification output 412 may comprise an indication of a class label of a set of class labels defined for a target parameter. For example, the classifier layer 606 may comprise a multi-class classifier, a binary classifier, and/or the like that is associated with one or more class labels. A class label, for example, may comprise a categorical identifier assigned to a specific instance or sample within a classification problem. Class labels represent the predefined categories or groups into which the classifier layer 606 is tasked with classifying input data. These labels serve as the target variables during the training of supervised classification models and as the output predictions when the trained model is applied to new, unseen data.

In some examples, a class label 610 may comprise one of a set of class labels (e.g., two or more) corresponding to the classifier layer 606. For instance, the set of class labels may correspond to a set of different numerical subranges of a defined numerical range for the target parameter. In some examples, the set of numerical subrange may comprise a reference range and/or one or more ranges relative to the reference range. The reference range, for example, may comprise a normal range of operation, such as a normal range for a particular lab test, a normal temperature range for a machinery component, and/or the like. By way of example, the reference range may identify range that indicates an unlikelihood of health complications in a clinical setting, safe operating conditions for machinery in an industrial setting, and/or the like.

In some examples, the set of different numerical subranges may comprise the reference range, a range that exceeds the reference range, and/or a range that falls below the reference range. By way of example, the set of different numerical subranges may comprise (i) a first numerical subrange corresponding to a positive label (e.g., “within the reference range”), (ii) a second numerical subrange that exceeds the first numerical subrange and corresponds to a first negative label (e.g., “beyond the reference range”), and/or (iii) a third numerical subrange that is less than the first numerical subrange and corresponds to a second negative label (e.g., “less than the reference range”). In this manner, a set of class labels that correspond to the set of different numerical ranges may provide a discrete representation of continuous numerical values, allowing the classification model to focus on predicting categorical outcomes rather than exact numerical values.

A numerical subrange may comprise a static and/or dynamic numerical subranges within the defined numerical range. For example, in clinical setting medicine, a reference range for a lab test may vary based on a patient's age, sex, or other health conditions. In addition, or alternatively, in an industrial setting, a reference range for a temperature measurement may vary based on a machine's location, age, or other environmental conditions. In such cases, the set of defined numerical subranges may be implemented as a function rather than static values, calculated on-the-fly based on relevant factors. In addition, or alternatively, the set of numerical subranges may comprise fuzzy ranges, where instead of hard cutoffs, there are gradual transitions between “normal” and “abnormal” values, implemented using fuzzy logic principles.

Whether static or dynamic, the use of discrete class labels corresponding to numerical subranges enables the transformation of complex time series prediction tasks into more manageable classification problems. This approach offers several advantages, including increased flexibility in model architecture selection, improved handling of multi-modal input data, the ability to leverage powerful classification algorithms that may not be directly applicable to time series forecasting, among others.

In some embodiments, the machine learned classification pipeline 410 is trained using a training dataset of training code sequences. Up to each of the training code sequences, for example, may be associated with a class label 610 corresponding to a training measurement 612 of the target parameter. In some examples, the machine learned classification pipeline 410 may be trained end-to-end. In addition, or alternatively, the embedding layer 602 and/or classifier layer 606 may be trained separately. For example, the embedding layer 602 may be pretrained and/or finetuned using the training dataset. In addition, or alternatively, the classifier layer 606 may be separately trained using the training dataset. The classifier layer 606, for example, may be trained after the embedding layer 602 is trained using one or more labeled training code sequences generated, in part, using the trained embedding layer 602.

By way of example, the machine learned classification pipeline 410 may be trained by generating, using the embedding layer 602 of the machine learned classification pipeline 410, a training sequence embedding corresponding to a training code sequence of the training dataset, generating, using the augmentation layer 604 of the machine learned classification pipeline 410, a training classification embedding by concatenating a predictive features, such as a training time attribute, training entity attributes, and/or the like, to the training sequence embedding, generating, using the classifier layer 606 of the machine learned classification pipeline 410, a training output for the training measurement 612 of the target parameter, and updating, using a training optimizer 614 and a loss function, one or more weights of the machine learned classification pipeline 410 (e.g., the classifier layer 606) based on the training output and the class label 610.

In some embodiments, a training code sequence is a structured representation of historical and/or synthetic data used for training a machine learned classification pipeline 410. The training code sequence, for example, may comprise code sequence 408 that is derived from historical data. In some examples, the training code sequence may comprise a set of code inputs extracted from a historical time period of an input dataset for the target entity and/or another input dataset for an unrelated or synthetic entity. The historical time period may comprise a period of time between two recorded measurements and/or before at least one recorded measurement. By way of example, the training code sequence may comprise a set time stamped events recorded between two previously recorded measurements for a target parameter (e.g., due to the classification architecture, the training data may be aggregated from a plurality of different entities instead of beginning limited to the target entity's data).

In some examples, a class label 610 may be assigned to a training code sequence based on a comparison between the training measurement 612 and the set of different numerical subranges. The training measurement 612, for example, may comprise a last recorded measurement within a historical time period. In some examples, the training measurement 612 may be masked from the training code sequence and used to assign a label for the training code sequence. In this manner, during training, up to each of a set of training code sequences may be associated with a known class label, which may serve as the ground truth for a supervised learning process. Using the training optimizer 614, the machine learned classification pipeline 410, and/or the classifier layer 606 thereof, may learn to map input features to these class labels by adjusting its internal parameters to minimize the discrepancy between predicted (e.g., classification output 412) and actual labels (e.g., class label 610). In the evaluation and inference phases, the machine learned classification pipeline 410 may generate a classification output 412 for new input data, which may then be compared to actual outcomes (e.g., subsequent measurements) to assess the model's performance and reliability over time.

In some embodiments, the training optimizer 614 comprise an algorithmic component responsible for adjusting the parameters of a machine learning model during a training process to improve (e.g., increase or decrease depending on the function) a model loss. The training optimizer 614, for example, may implement a backpropagation of errors training scheme, as optimized using gradient descent, to minimizing the difference between a model's predictions (e.g., classification output 412) and the actual target values (e.g., class label 610), thereby improving the model's performance over time. In some examples, the training optimizer 614 may employ iterative training techniques, such as gradient descent and/or its variants (e.g., stochastic gradient descent, Adam, RMSprop) to update the model's parameters. Such techniques may compute the gradient of a loss function with respect to the model's parameters and use this information to adjust the parameters in a direction that reduces the overall loss.

In some examples, the training optimizer 614 may be configured using one or more learning rates to control the size of parameter updates. In some examples, the learning rates may dynamically change according to a learning rate schedule that adjusts the learning rate over the course of training and/or retraining operations. By way of example, a first learning rate may be configured for an initial training process and a second, lower learning rate may be configured for a retraining process. The retraining process, for example, may be triggered in response to a model's post training performance dropping below a performance threshold (e.g., 70% accuracy). In addition, or alternatively, the training optimizer 614 may implement one or more regularization techniques to prevent overfitting, early stopping criteria to determine when to halt the training process, and/or the like.

In some embodiments, the loss function quantifies a discrepancy between a prediction (e.g., classification output 412) output by a machine learned classification pipeline 410 and a class label in the training data. The loss function may comprise any supervisory loss function, including cross-entropy loss (e.g., log loss) for binary classification, categorical cross-entropy for multi-class classification, and/or the like. In addition, or alternatively, to handle imbalanced training datasets, the loss function may comprise a weighted loss functions, focal loss, and/or the like. The loss functions may penalize incorrect predictions, reward correct predictions, and/or consider a model's confidence in its predictions, encouraging the model to produce well-calibrated probability estimates.

The machine learned classification pipeline 410 may be trained using a balanced and/or partially imbalanced training dataset. For example, the training data set may comprise a set of training code sequences with one or more equally sized (e.g., within a relative threshold) subsets each corresponding to one of a set of class labels. In addition, or alternatively, the training data set may comprise a set of training code sequences with one or more imbalanced subsets each corresponding to one of a set of class labels. The one or more imbalanced subsets, for example, may comprise a larger training subset for a positive label (e.g., “within a reference range”) and smaller training subsets for negative labels (e.g., “outside a reference range”) to reduce false negatives in favor of false positives. In this way, the machine learned classification pipeline 410 may be trained to detect outliers (e.g., “outside a reference range”) with improved accuracy.

In some examples, the machine learned classification pipeline 410 may be evaluated on a reoccurring interval to monitor the performance of the model. For example, the computing system 101 may determine one or more evaluation metrics, such as a precision, recall, and/or F1-score for the machine learned classification pipeline 410, at a defined frequency. By monitoring the machine learned classification pipeline 410 on a defined frequency, the computing system 101 may detect performance drift and trigger retraining operations.

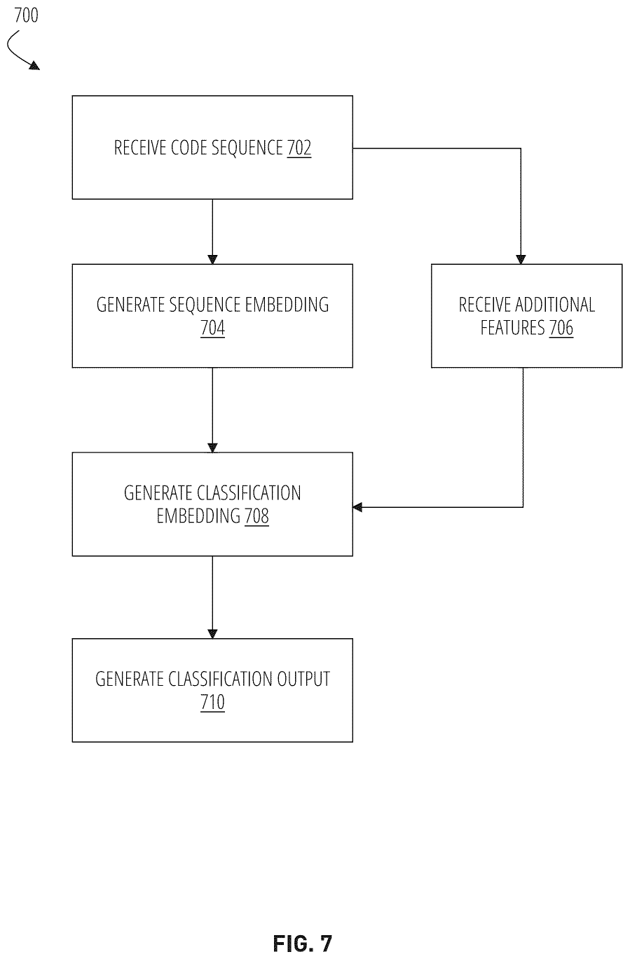

FIG. 7 depicts a flowchart diagram of a classification process 700 in accordance with some embodiments of the present disclosure. The flowchart diagram depicts a classification process 700 that applies a modified classifier framework to convert a traditionally regression or time-series prediction task to a classification task The classification process 700 may be implemented by one or more computing devices, entities, and/or systems described herein. For example, via the various steps/operations of the classification process 700, the computing system 101 may engineer features and generate embeddings that enable a generation of a classification inference to replace unreliable and resource intensive regression outputs. By doing so, the classification process 700 improve computer functionality by improving the model architecture flexibility for various computing task (e.g., allowing both classifier and regressor to be applied to the same computing task) and, in doing so, reducing training times and increasing the performance of machine learning model in various contexts.

FIG. 7 illustrates an example classification process 700 for explanatory purposes. Although the example classification process 700 depicts a particular sequence of steps/operations, the sequence may be altered without departing from the scope of the present disclosure. For example, some of the steps/operations depicted may be performed in parallel or in a different sequence that does not materially impact the function of the classification process 700. In other examples, different components of an example device or system that implements the classification process 700 may perform functions at substantially the same time or in a specific sequence.

In some embodiments, the classification process 700 comprises, at operation 702, receiving a code sequence. For example, the computing system 101 may receive the code sequence from an input dataset that is based on a target parameter associated with a defined numerical range. The code sequence may comprise a set of code inputs that is arranged in accordance with a set of time stamps (and/or arranged in a relative order if time stamps are unavailable) that (a) corresponds to a set of codes within the input dataset and/or (b) occurs within a predictive time period after a recorded measurement for the target parameter and before a subsequent measurement for the target parameter. A code input of the set of code inputs may comprise a time stamp of the set of time stamps and/or an input context corresponding to a code of the set of codes. In some examples, the set of code inputs may comprise an initial code input that comprises the recorded measurement, a measurement time stamp corresponding to the recorded measurement, and/or a contextual description (e.g., input context) of the target parameter.

In some embodiments, the classification process 700 comprises, at operation 704, generating a sequence embedding. For example, the computing system 101 may generate, using an embedding layer of a machine learned classification pipeline, a sequence embedding based on the code sequence. In some examples, the input context of a code input may comprise a textual description for the code, the code sequence may comprise a textual sequence, and/or the embedding layer may comprise a machine learned text embedding model. As another example, the input context may comprise a descriptive image for the code of a code input, the code sequence may comprise a sequence of annotated images, and/or the embedding layer may comprise a machine learned image embedding model.

In some embodiments, the classification process 700 comprises, at operation 706, receiving additional features. For example, the computing system 101 may receive the additional features. The additional features, for example, may comprise a time attribute and/or one or more entity attributes.

In some embodiments, the classification process 700 comprises, at operation 708, generating a classification embedding. For example, the computing system 101 may generate, using the augmentation layer of the machine learned classification pipeline, the classification embedding by concatenating a time attribute to the sequence embedding that indicates a duration of time between the recorded measurement for the target parameter and the subsequent measurement for the target parameter. In some examples, the input dataset may correspond to a target entity and the computing system 101 may further concatenate, using the augmentation layer of the machine learned classification pipeline, a set of entity attributes to the sequence embedding.

In some embodiments, the classification process 700 comprises, at operation 710, generating a classification output. For example, the computing system 101 may generate, using a classifier layer of the machine learned classification pipeline, and based on the classification embedding, the classification output for the subsequent measurement of the target parameter.

In some embodiments, the classifier layer of the machine learned classification pipeline comprises a machine learned classifier. In some examples, the machine learned classification pipeline that is trained by generating, using the embedding layer of the machine learned classification pipeline, a training sequence embedding corresponding to a training code sequence. The training code sequence, for example, may be associated with a class label corresponding to a training measurement of the target parameter. The machine learned classification pipeline may be trained by generating, using the augmentation layer of the machine learned classification pipeline, a training classification embedding by concatenating a training time attribute to the training sequence embedding, generating, using the classifier layer of the machine learned classification pipeline, a training output for the training measurement of the target parameter, and updating, using a training optimizer and a loss function, one or more weights of the machine learned classification pipeline based on the training output and the class label.

In some embodiments, the classifier layer is a multi-class classifier, and the class label is one of a set of class labels that correspond to a set of different numerical subranges of the defined numerical range. In some examples, the class label may be assigned to the training code sequence based on a comparison between the training measurement and the set of different numerical subranges. In some examples, the set of different numerical subranges may comprise (i) a first numerical subrange corresponding to a positive label, (ii) a second numerical subrange that exceeds the first numerical subrange and corresponds to a first negative label, and/or (iii) a third numerical subrange that is less than the first numerical subrange and corresponds to a second negative label.

In some embodiments, the subsequent measurement corresponds to a measurement time. The computing system 101 may initiate, at the measurement time, a measurement for the target parameter based on the classification output. For instance, the computing system 101 may initiate the measurement by prioritizing the target entity relative to a set of entities based on the classification output. In addition, or alternatively, the computing system 101 may perform one or more prediction-based actions based on the classification output.

Some techniques of the present disclosure enable the generation of action outputs that may be performed to initiate one or more real world actions to achieve real-world effects. The techniques of the present disclosure may be used, applied, and/or otherwise leveraged to generate classification outputs reflective of a future measurement that may be predictive of one or more adverse outcome for various entities, including patient, machinery, computers, and/or the like. In some examples, the classification outputs of the present disclosure may trigger action outputs (e.g., through control instructions) to automate clinical actions, such as the delivery of a pharmaceutical (e.g., insulin delivery), machine actions, such as an emergency override of a machine's operations, computer action, such as locking a computer access, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated drug delivery, automated machinery maintenance), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise, a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present), and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”,” “one or more”,” and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”,” “a feature”,” “one or more components”,” “one or more features”,” “a plurality of components”,” “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, a code sequence from an input dataset that is based on a target parameter associated with a defined numerical range, wherein (i) the code sequence comprises a set of code inputs that is arranged in accordance with a set of time stamps that (a) corresponds to a set of codes within the input dataset and (b) occurs within a predictive time period after a recorded measurement for the target parameter and before a subsequent measurement for the target parameter, and (ii) a code input of the set of code inputs comprises a time stamp of the set of time stamps and an input context corresponding to a code of the set of codes; generating, by the one or more processors and using an embedding layer of a machine learned classification pipeline, a sequence embedding based on the code sequence; generating, by the one or more processors and using an augmentation layer of the machine learned classification pipeline, a classification embedding by concatenating a time attribute to the sequence embedding that indicates a duration of time between the recorded measurement for the target parameter and the subsequent measurement for the target parameter; and generating, by the one or more processors, using a classifier layer of the machine learned classification pipeline, and based on the classification embedding, a classification output for the subsequent measurement of the target parameter.

Example 2. The computer-implemented method of claim 1, wherein the input context comprises a textual description for the code, the code sequence comprises a textual sequence, and the embedding layer comprises a machine learned text embedding model.

Example 3. The computer-implemented method of any of the preceding claims, wherein the input context comprises a descriptive image for the code, the code sequence comprises a sequence of annotated images, and the embedding layer comprises a machine learned image embedding model.

Example 4. The computer-implemented method of any of the preceding claims, wherein the classifier layer of the machine learned classification pipeline comprises a machine learned classifier that is trained by generating, using the embedding layer of the machine learned classification pipeline, a training sequence embedding corresponding to a training code sequence, wherein the training code sequence is associated with a class label corresponding to a training measurement of the target parameter; generating, using the augmentation layer of the machine learned classification pipeline, a training classification embedding by concatenating a training time attribute to the training sequence embedding; generating, using the classifier layer of the machine learned classification pipeline, a training output for the training measurement of the target parameter; and updating, using a training optimizer and a loss function, one or more weights of the machine learned classification pipeline based on the training output and the class label.

Example 5. The computer-implemented method of claim 4, wherein the classifier layer is a multi-class classifier, the class label is one of a set of class labels that respectively correspond to a set of different numerical subranges of the defined numerical range, and the class label is assigned to the training code sequence based on a comparison between the training measurement and the set of different numerical subranges.

Example 6. The computer-implemented method of claim 5, wherein the set of different numerical subranges comprises (i) a first numerical subrange corresponding to a positive label, (ii) a second numerical subrange that exceeds the first numerical subrange and corresponds to a first negative label, and (iii) a third numerical subrange that is less than the first numerical subrange and corresponds to a second negative label.

Example 7. The computer-implemented method of any of the preceding claims, wherein the input dataset corresponds to a target entity, and generating the classification embedding further comprises concatenating, using the augmentation layer of the machine learned classification pipeline, a set of entity attributes to the sequence embedding.

Example 8. The computer-implemented method of any of the preceding claims, wherein the set of code inputs comprises an initial code input that comprises the recorded measurement, a measurement time stamp corresponding to the recorded measurement, and a contextual description of the target parameter.

Example 9. The computer-implemented method of any of the preceding claims, wherein the subsequent measurement corresponds to a measurement time, and the computer-implemented method further comprises initiating, at the measurement time, a measurement for the target parameter based on the classification output.

Example 10. The computer-implemented method of claim 9, wherein the input dataset corresponds to a target entity and initiating the measurement comprises prioritizing the target entity relative to a set of entities based on the classification output.

Example 11. A system comprising one or more processors; and one or more memories storing processor-executable instructions that, when executed by the one or more processors, cause the one or more processors to perform operations comprising receiving a code sequence from an input dataset that is based on a target parameter associated with a defined numerical range, wherein (i) the code sequence comprises a set of code inputs that is arranged in accordance with a set of time stamps that (a) corresponds to a set of codes within the input dataset and (b) occurs within a predictive time period after a recorded measurement for the target parameter and before a subsequent measurement for the target parameter, and (ii) a code input of the set of code inputs comprises a time stamp of the set of time stamps and an input context corresponding to a code of the set of codes; generating, using an embedding layer of a machine learned classification pipeline, a sequence embedding based on the code sequence; generating, using an augmentation layer of the machine learned classification pipeline, a classification embedding by concatenating a time attribute to the sequence embedding that indicates a duration of time between the recorded measurement for the target parameter and the subsequent measurement for the target parameter; and generating, using a classifier layer of the machine learned classification pipeline, and based on the classification embedding, a classification output for the subsequent measurement of the target parameter.

Example 12. The system of claim 11, wherein the input context comprises a textual description for the code, the code sequence comprises a textual sequence, and the embedding layer comprises a machine learned text embedding model.

Example 13. The system of claims 11 or 12, wherein the input context comprises a descriptive image for the code, the code sequence comprises a sequence of annotated images, and the embedding layer comprises a machine learned image embedding model.

Example 14. The system of any of claims 11 through 13, wherein the classifier layer of the machine learned classification pipeline comprises a machine learned classifier that is trained by generating, using the embedding layer of the machine learned classification pipeline, a training sequence embedding corresponding to a training code sequence, wherein the training code sequence is associated with a class label corresponding to a training measurement of the target parameter; generating, using the augmentation layer of the machine learned classification pipeline, a training classification embedding by concatenating a training time attribute to the training sequence embedding; generating, using the classifier layer of the machine learned classification pipeline, a training output for the training measurement of the target parameter; and updating, using a training optimizer and a loss function, one or more weights of the machine learned classification pipeline based on the training output and the class label.

Example 15. The system of claim 14, wherein the classifier layer is a multi-class classifier, the class label is one of a set of class labels that respectively correspond to a set of different numerical subranges of the defined numerical range, and the class label is assigned to the training code sequence based on a comparison between the training measurement and the set of different numerical subranges.

Example 16. The system of claim 15, wherein the set of different numerical subranges comprises (i) a first numerical subrange corresponding to a positive label, (ii) a second numerical subrange that exceeds the first numerical subrange and corresponds to a first negative label, and (iii) a third numerical subrange that is less than the first numerical subrange and corresponds to a second negative label.

Example 17. The system of any of claims 15 through 16, wherein the input dataset corresponds to a target entity, and generating the classification embedding further comprises concatenating, using the augmentation layer of the machine learned classification pipeline, a set of entity attributes to the sequence embedding.

Example 18. One or more non-transitory computer-readable media storing processor-executable instructions that, when executed by one or more processors, cause the one or more processors to perform operations comprising receiving a code sequence from an input dataset that is based on a target parameter associated with a defined numerical range, wherein (i) the code sequence comprises a set of code inputs that is arranged in accordance with a set of time stamps that (a) corresponds to a set of codes within the input dataset and (b) occurs within a predictive time period after a recorded measurement for the target parameter and before a subsequent measurement for the target parameter, and (ii) a code input of the set of code inputs comprises a time stamp of the set of time stamps and an input context corresponding to a code of the set of codes; generating, using an embedding layer of a machine learned classification pipeline, a sequence embedding based on the code sequence; generating, using an augmentation layer of the machine learned classification pipeline, a classification embedding by concatenating a time attribute to the sequence embedding that indicates a duration of time between the recorded measurement for the target parameter and the subsequent measurement for the target parameter; and generating, using a classifier layer of the machine learned classification pipeline, and based on the classification embedding, a classification output for the subsequent measurement of the target parameter.

Example 19. The one or more non-transitory computer-readable media of claim 18, wherein the subsequent measurement corresponds to a measurement time, and the operations further comprise initiating, at the measurement time, a measurement for the target parameter based on the classification output.

Example 20. The one or more non-transitory computer-readable media of claim 19, wherein the input dataset corresponds to a target entity and initiating the measurement comprises prioritizing the target entity relative to a set of entities based on the classification output.

Example 21. The computer-implemented method of example 1, wherein the method further comprises training the machine learned classification pipeline.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the machine learned classification pipeline.

Example 25. The computing system of example 24, wherein the one or more processors are comprised in a first computing entity; and the machine learned classification pipeline is trained by one or more other processors comprised in a second computing entity.

Example 26. The one or more non-transitory computer-readable storage media of example 18, wherein the instructions further cause the one or more processors to train the machine learned classification pipeline.

Example 27. The one or more non-transitory computer-readable storage media of example 26, wherein the one or more processors are comprised in a first computing entity; and the machine learned classification pipeline is trained by one or more other processors comprised in a second computing entity.

What is claimed is:

1. A computer-implemented method comprising:
receiving, by one or more processors, a code sequence from an input dataset that is based on a target parameter associated with a defined numerical range, wherein:
(i) the code sequence comprises a set of code inputs that is arranged in accordance with a set of time stamps that (a) corresponds to a set of codes within the input dataset and (b) occurs within a predictive time period after a recorded measurement for the target parameter and before a subsequent measurement for the target parameter, and
(ii) a code input of the set of code inputs comprises a time stamp of the set of time stamps and an input context corresponding to a code of the set of codes;
generating, by the one or more processors and using an embedding layer of a machine learned classification pipeline, a sequence embedding based on the code sequence;
generating, by the one or more processors and using an augmentation layer of the machine learned classification pipeline, a classification embedding by concatenating a time attribute to the sequence embedding that indicates a duration of time between the recorded measurement for the target parameter and the subsequent measurement for the target parameter; and
generating, by the one or more processors, using a classifier layer of the machine learned classification pipeline, and based on the classification embedding, a classification output for the subsequent measurement of the target parameter.

2. The computer-implemented method of claim 1, wherein the input context comprises a textual description for the code, the code sequence comprises a textual sequence, and the embedding layer comprises a machine learned text embedding model.

3. The computer-implemented method of claim 1, wherein the input context comprises a descriptive image for the code, the code sequence comprises a sequence of annotated images, and the embedding layer comprises a machine learned image embedding model.

4. The computer-implemented method of claim 1, wherein the classifier layer of the machine learned classification pipeline comprises a machine learned classifier that is trained by:
generating, using the embedding layer of the machine learned classification pipeline, a training sequence embedding corresponding to a training code sequence, wherein the training code sequence is associated with a class label corresponding to a training measurement of the target parameter;
generating, using the augmentation layer of the machine learned classification pipeline, a training classification embedding by concatenating a training time attribute to the training sequence embedding;
generating, using the classifier layer of the machine learned classification pipeline, a training output for the training measurement of the target parameter; and
updating, using a training optimizer and a loss function, one or more weights of the machine learned classification pipeline based on the training output and the class label.

5. The computer-implemented method of claim 4, wherein the classifier layer is a multi-class classifier, the class label is one of a set of class labels that respectively correspond to a set of different numerical subranges of the defined numerical range, and the class label is assigned to the training code sequence based on a comparison between the training measurement and the set of different numerical subranges.

6. The computer-implemented method of claim 5, wherein the set of different numerical subranges comprises (i) a first numerical subrange corresponding to a positive label, (ii) a second numerical subrange that exceeds the first numerical subrange and corresponds to a first negative label, and (iii) a third numerical subrange that is less than the first numerical subrange and corresponds to a second negative label.

7. The computer-implemented method of claim 1, wherein the input dataset corresponds to a target entity, and generating the classification embedding further comprises concatenating, using the augmentation layer of the machine learned classification pipeline, a set of entity attributes to the sequence embedding.

8. The computer-implemented method of claim 1, wherein the set of code inputs comprises an initial code input that comprises the recorded measurement, a measurement time stamp corresponding to the recorded measurement, and a contextual description of the target parameter.

9. The computer-implemented method of claim 1, wherein the subsequent measurement corresponds to a measurement time, and the computer-implemented method further comprises:
initiating, at the measurement time, a measurement for the target parameter based on the classification output.

10. The computer-implemented method of claim 9, wherein the input dataset corresponds to a target entity and initiating the measurement comprises prioritizing the target entity relative to a set of entities based on the classification output.

11. A system comprising:
one or more processors; and
one or more memories storing processor-executable instructions that, when executed by the one or more processors, cause the one or more processors to perform operations comprising:
receiving a code sequence from an input dataset that is based on a target parameter associated with a defined numerical range, wherein:
(i) the code sequence comprises a set of code inputs that is arranged in accordance with a set of time stamps that (a) corresponds to a set of codes within the input dataset and (b) occurs within a predictive time period after a recorded measurement for the target parameter and before a subsequent measurement for the target parameter, and
(ii) a code input of the set of code inputs comprises a time stamp of the set of time stamps and an input context corresponding to a code of the set of codes;
generating, using an embedding layer of a machine learned classification pipeline, a sequence embedding based on the code sequence;
generating, using an augmentation layer of the machine learned classification pipeline, a classification embedding by concatenating a time attribute to the sequence embedding that indicates a duration of time between the recorded measurement for the target parameter and the subsequent measurement for the target parameter; and
generating, using a classifier layer of the machine learned classification pipeline, and based on the classification embedding, a classification output for the subsequent measurement of the target parameter.

12. The system of claim 11, wherein the input context comprises a textual description for the code, the code sequence comprises a textual sequence, and the embedding layer comprises a machine learned text embedding model.

13. The system of claim 11, wherein the input context comprises a descriptive image for the code, the code sequence comprises a sequence of annotated images, and the embedding layer comprises a machine learned image embedding model.

14. The system of claim 11, wherein the classifier layer of the machine learned classification pipeline comprises a machine learned classifier that is trained by:
generating, using the embedding layer of the machine learned classification pipeline, a training sequence embedding corresponding to a training code sequence, wherein the training code sequence is associated with a class label corresponding to a training measurement of the target parameter;
generating, using the augmentation layer of the machine learned classification pipeline, a training classification embedding by concatenating a training time attribute to the training sequence embedding;
generating, using the classifier layer of the machine learned classification pipeline, a training output for the training measurement of the target parameter; and
updating, using a training optimizer and a loss function, one or more weights of the machine learned classification pipeline based on the training output and the class label.

15. The system of claim 14, wherein the classifier layer is a multi-class classifier, the class label is one of a set of class labels that respectively correspond to a set of different numerical subranges of the defined numerical range, and the class label is assigned to the training code sequence based on a comparison between the training measurement and the set of different numerical subranges.

16. The system of claim 15, wherein the set of different numerical subranges comprises (i) a first numerical subrange corresponding to a positive label, (ii) a second numerical subrange that exceeds the first numerical subrange and corresponds to a first negative label, and (iii) a third numerical subrange that is less than the first numerical subrange and corresponds to a second negative label.

17. The system of claim 15, wherein the input dataset corresponds to a target entity, and generating the classification embedding further comprises concatenating, using the augmentation layer of the machine learned classification pipeline, a set of entity attributes to the sequence embedding.

18. One or more non-transitory computer-readable media storing processor-executable instructions that, when executed by one or more processors, cause the one or more processors to perform operations comprising:
receiving a code sequence from an input dataset that is based on a target parameter associated with a defined numerical range, wherein:
(i) the code sequence comprises a set of code inputs that is arranged in accordance with a set of time stamps that (a) corresponds to a set of codes within the input dataset and (b) occurs within a predictive time period after a recorded measurement for the target parameter and before a subsequent measurement for the target parameter, and
(ii) a code input of the set of code inputs comprises a time stamp of the set of time stamps and an input context corresponding to a code of the set of codes;
generating, using an embedding layer of a machine learned classification pipeline, a sequence embedding based on the code sequence;
generating, using an augmentation layer of the machine learned classification pipeline, a classification embedding by concatenating a time attribute to the sequence embedding that indicates a duration of time between the recorded measurement for the target parameter and the subsequent measurement for the target parameter; and
generating, using a classifier layer of the machine learned classification pipeline, and based on the classification embedding, a classification output for the subsequent measurement of the target parameter.

19. The one or more non-transitory computer-readable media of claim 18, wherein the subsequent measurement corresponds to a measurement time, and the operations further comprise:
initiating, at the measurement time, a measurement for the target parameter based on the classification output.

20. The one or more non-transitory computer-readable media of claim 19, wherein the input dataset corresponds to a target entity and initiating the measurement comprises prioritizing the target entity relative to a set of entities based on the classification output.
